(19) United States
(12) Patent Application Publication
(10) Pub. No.: US 2026/0304087 A1
(43) Pub. Date: Oct. 1, 2026

(54) NFC DEVICE

(71) Applicant: STMicroelectronics International N.V., Geneva (CH)

(72) Inventors: Sylvain ENGELS, MEYLAN (FR); Julien MERCIER, Mimet (FR)

(73) Assignee: STMicroelectronics International N.V., Geneva (CH)

(21) Appl. No.: 19/569,367

(22) Filed: Mar. 17, 2026

(30) Foreign Application Priority Data
Mar. 31, 2025 (FR) FR2503302

(51) Int. Cl. H04W 4/80

(52) U.S. Cl. CPC H04W 4/80

(57) ABSTRACT

The present description relates to an NFC device configured to, in a card mode: when it receives a frame which it identifies as invalid, store all or part of said frame in a first memory of the device; and analyze all or part of said frame.

### PRIORITY CLAIM

This application claims the priority benefit of French Application for Patent No. FR2503302, filed on Mar. 31, 2025, the content of which is hereby incorporated by reference in its entirety to the maximum extent allowable by law.

### TECHNICAL FIELD

The present disclosure generally concerns NFC devices and their operating methods.

### BACKGROUND

Some NFC standards or protocols, such as the ISO 14443-3:2018 standard or the NFC Forum standards for type A or type B, do not provide satisfactory solutions to address certain situations.

There exists a need to provide NFC devices that enable addressing certain situations relative to the reception of unexpected frames, whether erroneous or not.

There is a need to overcome all or part of the disadvantages of known devices.

### SUMMARY

An embodiment provides an NFC device configured to, in a card emulation mode: when it receives a frame that it identifies as invalid, store all or part of said frame in a first memory of the device; and analyze all or part of said frame.

According to an embodiment, the analysis is performed by a program stored in said device.

An embodiment provides a method of operation of an NFC device, comprising: in a card emulation mode, when the device receives a frame that it identifies as invalid, storing all or part of said frame in a first memory of the device; and analyzing, for example by execution of a program, all or part of said frame.

According to an embodiment, depending on the analysis, the program causes a change in the operation of the device.

According to an embodiment, depending on the analysis, an operating mode of the device is modified.

According to an embodiment, the identification of the frame as invalid is performed by a radio frequency decoder.

According to an embodiment, the identification of the frame as invalid corresponds to the reception of a short frame as defined in the ISO 14443-3:2018 standard when the NFC device is in a protocol state, otherwise known as protocol mode, of the proximity inductively coupled card emulation mode.

According to an embodiment, said short frame is non-erroneous.

According to an embodiment, when the NFC device is in said protocol state or mode, said short frame is decoded before being stored in said first memory.

According to an embodiment, after decoding, an interruption of the protocol state or mode is generated.

According to an embodiment, the device is configured to, in response to said interruption, store in a second memory of the device at least one reception event.

According to an embodiment, the second memory is a register.

According to an embodiment, the reception event and the content of said frame are analyzed by the device to modify an operating mode of the device.

According to an embodiment, the reception event and the content of said frame are analyzed by the program to modify an operating mode of the device.

According to an embodiment, in response to the reception of said short frame, the device implements a proprietary mode different from the protocol state or mode defined in the ISO 14443-3:2018 standard.

According to an embodiment, the identification of the frame as invalid corresponds to the identification of an error associated with said frame.

According to an embodiment, the error corresponds to at least one erroneous bit, a modulation error, a cyclic redundancy code error, a parity error, or a timing error.

According to an embodiment, said frame identified as invalid is decoded and then stored in said first memory.

According to an embodiment, the identification of said error is accompanied by: the generation, by the radio frequency decoder, of a status relating to said error, and its storage in a third memory of the device; and waking up a processing unit of the device to start the analysis; said status relating to said error and the content of said frame being analyzed, after waking up said processing unit, to modify a state or mode of operation of the device.

According to an embodiment, the third memory is, for example, a register.

According to an embodiment, as a result of the analysis of the status relating to said error and of the content of said frame, the device switches to an idle mode, an activation mode, or a proprietary mode.

According to an embodiment, when the identification of said error takes place in a protocol mode, then the identification of said error is accompanied by an interruption of the protocol mode.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows a very simplified view of an NFC device of an NFC system to which the embodiments apply;

FIG. 2 shows a method of operation of an NFC device of FIG. 1 according to the ISO 14443-3:2018 standard;

FIG. 3 shows a method of operation of an NFC device of FIG. 1 according to an example;

FIG. 4 shows a method of operation of an NFC device of FIG. 1 according to an example;

FIG. 5 shows an operating method of an NFC device of FIG. 1 according to an embodiment; and

FIG. 6 shows a method of operation of the NFC device of FIG. 1 according to an embodiment.

### DETAILED DESCRIPTION

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and have been described in detail.

Unless otherwise specified, when reference is made to two elements being connected to each other, this means directly connected without any intermediate elements other than conductors, and when reference is made to two elements being coupled to each other, this means that these two elements may be connected or may be connected via one or more other elements.

In the following description, where reference is made to absolute position qualifiers, such as the terms "front", "back", "top", "bottom", "left", "right", etc., or relative position qualifiers, such as the terms "top", "bottom", "upper", "lower", etc., or orientation qualifiers, such as "horizontal", "vertical", etc., reference is made unless otherwise specified to the orientation of the drawings.

Unless specified otherwise, the expressions "about", "approximately", "substantially", and "in the order of" signify plus or minus 10% or 10°, preferably of plus or minus 5% or 5°.

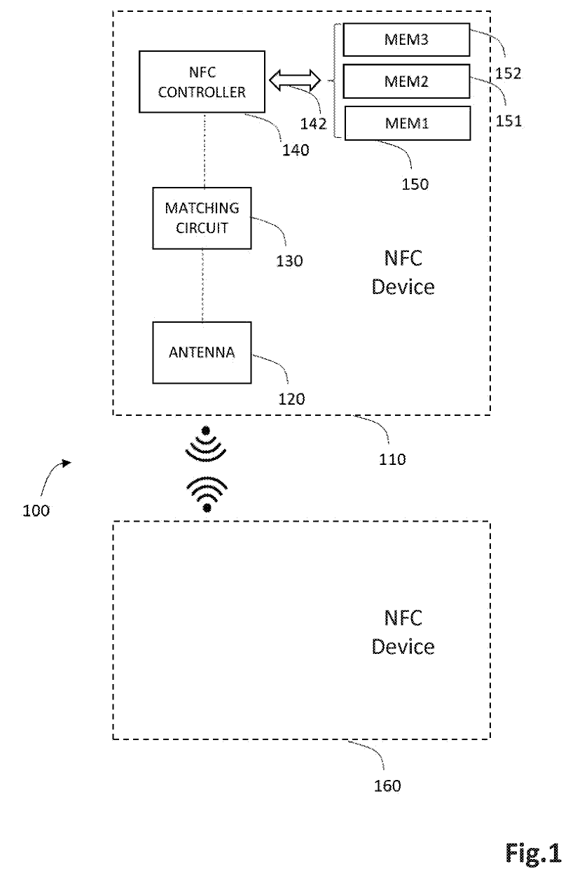

FIG. 1 shows a very simplified view of an NFC system 100 to which the embodiments apply.

NFC system 100 comprises a first NFC device 110 that can communicate with a second NFC device 160. This NFC technology concerns the establishment of very short-distance communications (less than ten centimeters) between these two devices 110, 160.

NFC systems, or in other words near-field communication systems, use a radio frequency electromagnetic field generated by one of the two devices 110, 160 set to terminal or reader mode to communicate with the other device 110, 160 in card emulation mode. The reverse is also possible. A same device can, particularly in the case of cell phones, operate in reader mode by generating a field intended for another device, or in card emulation mode by capturing a field generated by another device.

During a data transmission between one of the devices 110, 160 in reader mode and the other device 110, 160 in card or tag emulation mode, the reader generates a magnetic field via its antenna, which is generally a sine wave at 13.56 MHz in conventionally used standards.

This NFC technology also enables an NFC device to power one or more other NFC devices placed close to it.

In the present disclosure, the case of a system in which NFC devices 110, 160 are compatible with NFC technology by taking up all or part of the specifications of the NFC Forum for type A or type B or of the ISO 14443-3:2018 standard is considered.

In the example of FIG. 1, NFC device 110 comprises a matching circuit 130 coupling an antenna 120 to an NFC controller 140.

NFC controller 140 is for example implemented as a processing unit containing, for example, a microprocessor further coupled to one or more memories 150 (MEM1), 151 (MEM2), and 152 (MEM3), which are for example volatile or non-volatile memories, via a communication bus 142. Memories 150, 151, and 152 comprise, for example, registers for storing configuration data of NFC controller 140 or information relating to NFC communication, such as data resulting from radio frequency decoding. Memories 150, 151, and 152 are, for example, volatile memories such as RAM-type memories or registers. In one example, memories 150, 151, and 152 are implemented as a single memory. In one example, NFC controller 140 comprises a decoding circuit. In another example, NFC controller 140 is configured to execute one or more programs.

In one example, one of the two devices 110 or 160 has no power supply and is powered by the electromagnetic field of the other device, which is set in proximity coupling device (PCD) mode.

One of the NFC devices 110 or 160 is, for example, a phone, a smartphone, or a terminal operating in reader mode.

This enables information to be exchanged between one of the NFC devices acting as a contactless reader and secure elements located in the other NFC device, for example. Numerous applications are thus possible, such as mobile ticketing for public transport (the card or the cell phone used as a transport ticket) or payment (the card or cell phone used as a payment card). Other applications can also be envisaged, such as integration into a passport.

In one example, all blocks 130, 140, 142, 150, 151, and 152 are included in a microcontroller.

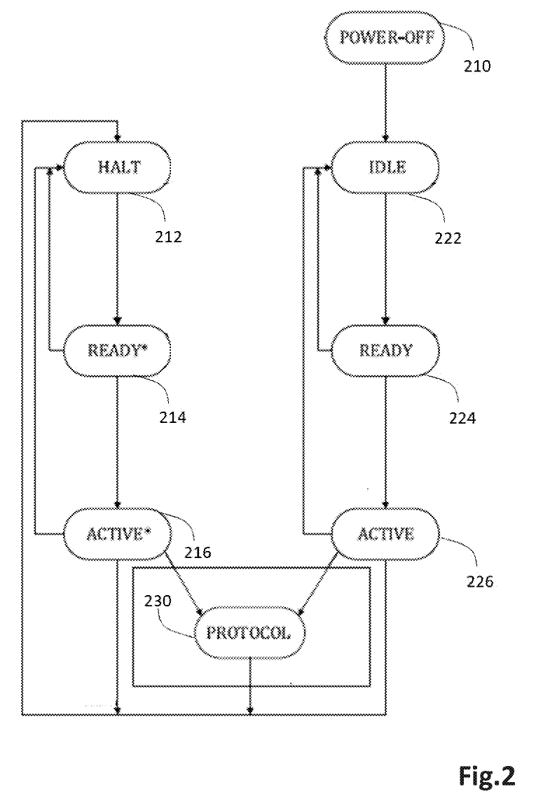

FIG. 2 shows a method of operation of an NFC device of the system of FIG. 1 according to the ISO 14443-3:2018 standard. More particularly, FIG. 2 shows a method of operation of one of NFC devices 110, 160 operating as a proximity inductively coupled card (PICC).

The example of FIG. 2 very schematically shows the possible state transitions for an NFC device 110, 160 in PICC proximity inductive coupling card mode.

In the text, the PICC proximity inductive coupling card mode may be referred to interchangeably as "card emulation mode".

In a step 210 (POWER-OFF), device 110 or 160 operating as an inductively coupled proximity card enters an electromagnetic field generated by the other device set to reader mode (PCD). When the electromagnetic field of the reader exceeds a certain value, then a step 222 (IDLE) is carried out. The first frame expected after step 210 is called a short frame. It has a specific format comprising a start condition, seven bits, and an end condition.

Step 222 corresponds to a so-called idle state or mode (IDLE). In the IDLE state or mode, the PICC device is powered by the electromagnetic field of the other NFC device. The PICC device listens for commands called REQA and WUPA (respectively REQB, WUPB for type B) as defined in the standards. When these commands are validly received and a query response called ATQA (respectively ATQB) has been sent to the other device, then a step 224 (READY) is implemented.

Step 224 corresponds to a so-called ready state or mode. In the READY state, an anticollision procedure is applied and a unique identifier (UID) is obtained.

When the unique identifier is selected, then a step 226 (ACTIVE) is implemented.

Step 226 corresponds to a state or mode known as active. In the ACTIVE state, the device in PICC mode can accept receiving protocol activation commands (RATS) or proceed according to other methods.

When a valid HLTA-type command is received, then a step 212 (HALT) is implemented.

Step 212 corresponds to a so-called halt state or mode (HALT). In the HALT state, the device in PICC mode must only respond to a WUPA-type command.

When a valid WUPA-type command is received and a query response called ATQA (respectively ATQB) has been sent to the other device, then a step 214 (READY*) is implemented.

Step 214 corresponds to a so-called ready state or mode (READY*) similar to the READY state except with respect to transitions between states. When a unique identifier UID is received in full at this stage, then a step 216 (ACTIVE*) is implemented.

Step 216 corresponds to a so-called active state or mode (ACTIVE*) similar to the ACTIVE state. When, in the ACTIVE and ACTIVE* states, the device in PICC mode receives valid protocol activation commands (RATS), then a step 230 (PROTOCOL) is implemented.

Step 230 corresponds to a so-called protocol state or mode (PROTOCOL) in which the device in PICC mode is powered by the electromagnetic field of the other device, and communication is established according to a communication protocol type defined by protocol-type information data. In the PROTOCOL state, the expected format of received frames is a so-called standard format comprising at least one byte, parity bits, and a cyclic redundancy code encoded over two bytes.

In the example of FIG. 2, which illustrates the ISO 14443-3:2018 standard, in the ACTIVE and READY states, it is possible to return to the IDLE state, for example when frame errors are detected. Similarly, in the ACTIVE* and READY* states, it is possible to return to the HALT state, for example when frame errors are detected.

The example of FIG. 2 is simplified, and reference should be made to the ISO 14443-3:2018 standard for full implementation details.

Generally, an NFC device acting as a PICC according to the ISO 14443-3:2018 standard or the provisions of the NFC Forum should only respond to an incoming frame if the latter is valid. No response should be sent when transmission errors are detected except, possibly, in the ACTIVE or ACTIVE* activation states.

In the remainder of the description, a frame is said to be invalid if it is erroneous, for example if the frame contains an error corresponding to at least one erroneous bit, a modulation error, a cyclic redundancy check error (CRC), a parity error, or a timing error. Further, in the description, a frame is said to be invalid if it does not contain an error but if, for example, the received frame is of a format that is unexpected for the state or mode in which the PICC device 110, 160 is operating. In one example, if the PICC device is in the PROTOCOL state and the received frame is of the short frame type, then, although it does not contain an error, according to ISO 14443-3:2018, this short frame is rejected because a standard-type frame is expected instead.

In some cases, a short frame is received during the PROTOCOL state of the device 110, 160 placed in PICC mode. It may nevertheless be useful to be able to use, or at least analyze, this frame even if ISO 14443-3:2018 or the NFC Forum do not describe these possibilities.

In other cases, the frame received, for example in protocol or activation modes, is erroneous. It may nevertheless be useful to be able to use, or at least analyze, this frame even if ISO 14443-3:2018 or the NFC Forum do not describe these possibilities.

The following embodiments provide an NFC device configured to, in a PICC proximity inductive coupling card mode: when it receives a frame that it identifies as invalid, store all or part of said frame in a first memory of the device; and analyze, by execution of a program, all or part of said frame.

This improves interoperability with systems that do not fully implement ISO 14443-3:2018 or the NFC Forum recommendations.

This also provides the flexibility to implement proprietary protocols.

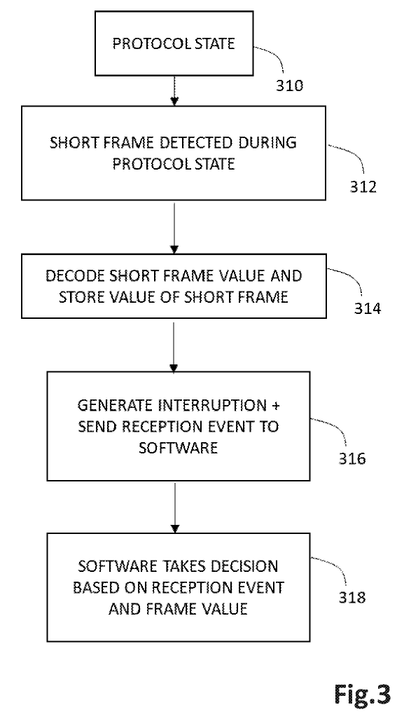

FIG. 3 shows a method of operation for the NFC device shown in FIG. 1. In particular, the example shown in FIG. 3 represents an operating procedure for one of the devices 110, 160 when in PICC card mode.

In a step 310 (PROTOCOL STATE), device 110, 160 is in the PROTOCOL state.

In a step 312 (Short frame detected during protocol state), subsequent to step 310, a short frame, as defined in ISO 14443-3:2018, is detected during the PROTOCOL state.

In a step 314 (Decode short frame value and store value of short frame), subsequent to step 312, the short frame is decoded by a radio frequency decoder circuit used, for example, in step 210 of FIG. 2. The decoded frame is stored in memory 150, for example.

In a step 316 (Generate interruption + send reception event to software), subsequent to step 314, a protocol state interruption is generated at the end of short-frame decoding. In this step, the radio frequency decoder also generates a reception event, which is stored, for example, in memory 151 or in one of the memories or registers 151, 152. The decoded frame, and optionally the reception event, are sent for processing by a program implemented, for example, by the NFC controller 140.

In a step 318 (Software takes decision based on reception event and frame value), subsequent to step 316, the program evaluates the decoded frame, and optionally the reception event, to implement one or more actions.

Examples of actions decided by the program include sending an error response, choosing to return to IDLE mode, saving the event, or returning to a state of waiting for a new frame in the PROTOCOL state.

This makes it possible, for example, to support readers that are not compatible with ISO 14443-3:2018.

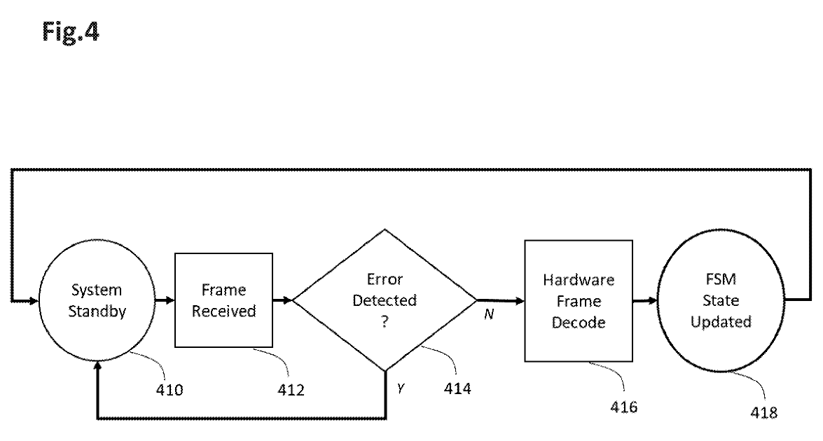

FIG. 4 shows an example of how to operate an NFC device as shown in FIG. 1.

In particular, the example shown in FIG. 4 illustrates a process for operating devices 110, 160 in PICC card mode.

In a step 410 (System standby), the device 110, 160 in PICC mode is idle. This corresponds, for example, to the IDLE or HALT states shown in FIG. 2.

In a step 412 (Frame received), subsequent to step 410, a frame is received.

In a step 414 (Error detected?), subsequent to step 412, if the frame is erroneous (branch Y), the process returns to step 410. If the frame is not erroneous (branch N), then step 416 (Hardware Frame Decode) is implemented.

In step 416, the received frame is decoded by the radio frequency decoder circuit.

In a step 418 (FSM state updated), subsequent to step 416, the device state is updated and step 410 is implemented again.

The procedure shown in FIG. 4 does not allow the use of an erroneous frame.

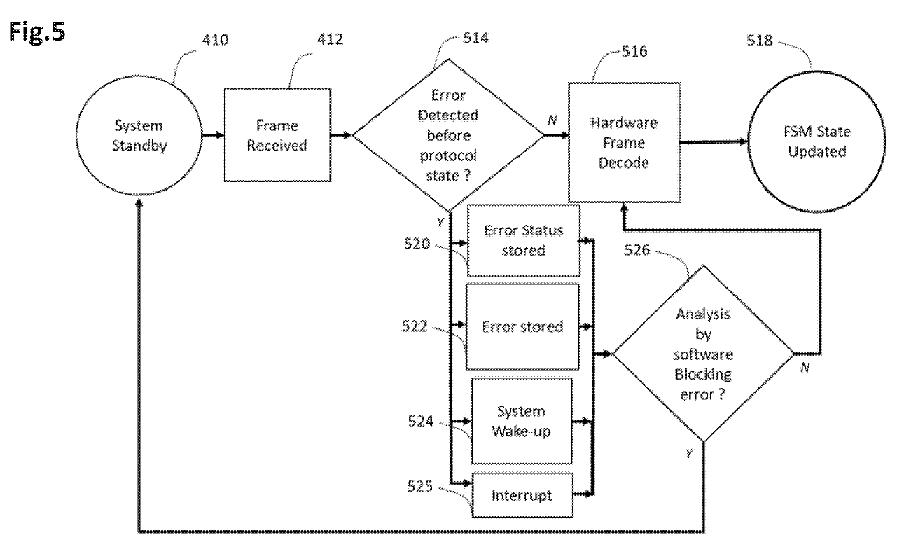

FIG. 5 shows an operating procedure for the NFC device shown in FIG. 1.

In particular, FIG. 5 shows an operating procedure for devices 110, 160 in the PICC proximity inductive coupling card mode.

The process shown in FIG. 5 comprises steps 410 and 412 of FIG. 4.

In a step 514 (Error detected before protocol state?), subsequent to step 412, if the frame received before the protocol state, that is, in ACTIVE activation mode, is recognized as erroneous (branch Y), for example by the radio frequency decoder, then steps 520 (Error status stored), 522 (Frame stored), 524 (System wake-up), and 525 (Interrupt) are implemented. Steps 520, 522, 524, and 525 may be implemented in parallel, successively, or in another order. Step 522 is optional.

If, in step 514, the frame received before the protocol state is not erroneous (branch N), then step 516 (Hardware frame decode) is implemented.

Step 516 is, for example, similar to step 416 of FIG. 4.

In step 520, the frame is stored in memory 150, for example.

In step 522, an error status relating to the error detected by the radio frequency decoder is stored, for example, in one of the memories or registers 151, 152.

In step 524, the NFC controller 140 is woken up.

In step 525, an end-of-reception interruption is implemented. This interruption corresponds to detection of the received, unmodulated electromagnetic field for a certain period of time.

In one example, following steps 520, 524, and optionally step 522, the NFC controller 140 is woken up and a step 526 (Analysis by software – blocking error?) is carried out.

Step 526 comprises analysis of the stored frame, and optionally the error status, by the program executed by the NFC controller 140.

If, in step 526, the error is analyzed as blocking (branch Y), then the PICC device 110, 160 is reset to the IDLE state or to a proprietary state, for example. If the error is analyzed as non-blocking (branch N), then step 516 is implemented followed by a step 518 (FSM state updated), which is similar, for example, to step 418.

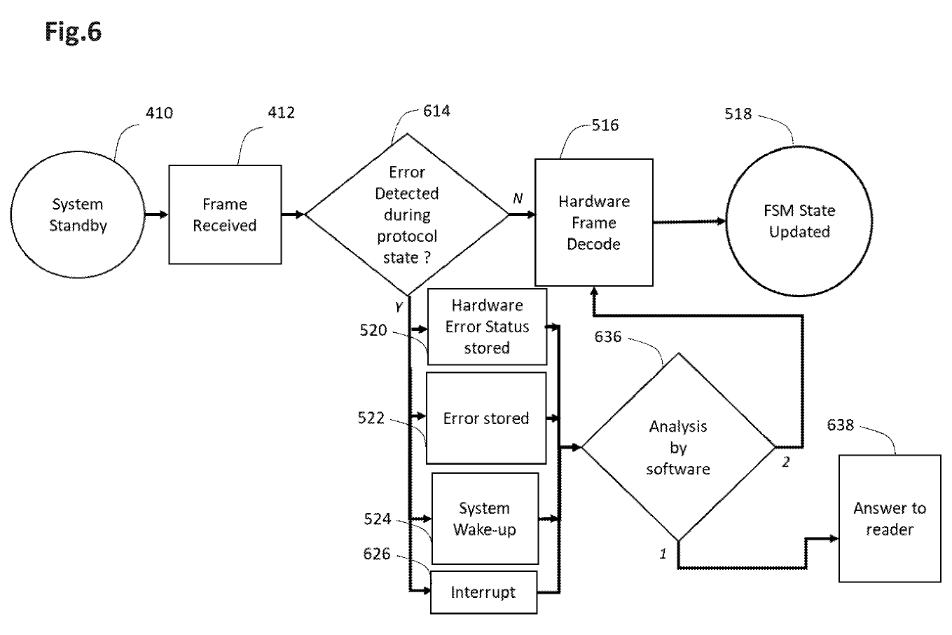

FIG. 6 shows an operating procedure for the NFC device shown in FIG. 1. In particular, FIG. 6 shows an operating procedure for one of the devices 110, 160 placed in PICC card mode.

The process shown in FIG. 6 comprises steps 410 and 412 of FIG. 4.

In a step 614 (Error detected during protocol state?), subsequent to step 412, if the frame received during the protocol state is recognized as erroneous (branch Y), for example by the radio frequency decoder, then a step 626 (Interrupt) is implemented. Optionally, steps 520, 522, and 524 of FIG. 5 are implemented in parallel or successively with step 626.

In step 626, an end-of-reception interruption is implemented. This interruption corresponds to detection of the received, unmodulated electromagnetic field for a certain period of time. Step 626 is similar, for example, to step 525.

Following step 626, a step 636 (Analysis by software) is implemented. In step 636, a program executed, for example, by the NFC controller 140 analyzes the stored frame and optionally the error status. A first possible action (branch 1) is to implement a step 638 (Answer to reader). In step 638, a response is sent to the device 110, 160 operating in reader mode. This makes it possible to offer options not provided for in ISO 14443-3:2018.

A second possible action (branch 2) in step 636 is to implement step 516 of FIG. 4.

The examples shown in FIGS. 5 and 6 improve interoperability and flexibility of use of devices 110, 160 in card mode.

Various embodiments and variants have been described. The person skilled in the art will understand that certain features of these various embodiments and variants could be combined, and other variants will become apparent to the person skilled in the art. In particular, it is possible, for example, to combine the examples of FIGS. 3, 5 and 6 to cover the case of an invalid but not erroneous frame, the case of an erroneous frame received before the protocol mode, and the case of an erroneous frame received during the protocol mode.

Finally, the practical implementation of the described embodiments and variants is within the reach of the person skilled in the art on the basis of the functional indications given above. In particular, with regard to the nature of the frames shown in FIGS. 5 and 6, these examples are compatible with various frame types, such as standard, XECC or proprietary frames.

1. An NFC device, comprising:
an antenna;
a radio frequency decoder coupled to the antenna;
a first memory; and
an NFC controller comprising a processing unit coupled to the first memory,
wherein, in a card mode:
the radio frequency decoder is configured to identify a received frame as invalid;
the radio frequency decoder is configured to cause storage of a portion of the invalid frame in the first memory; and
the NFC controller is configured to analyze the invalid frame stored in the first memory.

2. The NFC device according to claim 1, wherein the NFC controller is configured to modify an operating mode of the NFC device based on the analysis of the invalid frame.

3. The NFC device according to claim 1, wherein identification of the frame as invalid corresponds to reception, by the radio frequency decoder, of a short frame as defined in ISO 14443-3:2018 while the NFC device is operating in a protocol mode of a proximity inductively coupled card mode.

4. The NFC device according to claim 3, wherein the NFC controller is configured to switch the NFC device to a proprietary mode different from the protocol mode defined in ISO 14443-3:2018 in response to receipt of the short frame.

5. The NFC device according to claim 3, wherein the radio frequency decoder is configured to decode the short frame before the short frame is stored in the first memory.

6. The NFC device according to claim 5, wherein the radio frequency decoder is configured to generate a protocol mode interrupt after decoding the short frame.

7. The NFC device according to claim 6, further comprising a second memory, wherein the NFC controller is configured, in response to the protocol mode interrupt, to store a reception event in the second memory.

8. The NFC device according to claim 7, wherein the NFC controller is configured to analyze the reception event and the stored portion of the invalid frame and to modify an operating mode of the NFC device based on said analysis.

9. The NFC device according to claim 1, wherein identification of the frame as invalid corresponds to identification, by the radio frequency decoder, of an error associated with the frame.

10. The NFC device according to claim 9, wherein the radio frequency decoder is configured to decode the frame identified as invalid before the frame is stored in the first memory.

11. A method of operating an NFC device, the method comprising:
in a card mode, when the NFC device receives a frame which it identifies as invalid, storing all or part of said frame in a first memory of the NFC device; and
analyzing all or part of said frame.

12. The method according to claim 11, in which, depending on the analysis, an operating mode of the NFC device is modified.

13. The method according to claim 11, in which identification of the frame as invalid is implemented by a radio frequency decoder.

14. The method according to claim 11, wherein the identification of the frame as invalid corresponds to the reception of a short frame as defined in ISO 14443-3:2018 when the NFC device is in a protocol mode of a Proximity Inductive Coupled Card mode.

15. The method according to claim 14, wherein, when the NFC device is in said protocol mode, said short frame is decoded before being stored in said first memory.

16. The method according to claim 15, in which, after decoding, a protocol mode interrupt is generated.

17. The method according to claim 16, wherein the NFC device is configured to, following said protocol mode interrupt, store in a second memory of the NFC device at least one reception event.

18. The method according to claim 17, wherein the reception event and the content of said frame are analyzed by the NFC device to modify an operating mode of the NFC device.

19. The method according to claim 14, wherein, following receipt of said short frame, the NFC device switches to a proprietary mode different from the protocol mode defined in ISO 14443-3:2018.

20. The method according to claim 11, wherein the identification of the frame as invalid corresponds to the identification of an error associated with said frame.

21. The method according to claim 20, wherein said frame identified as invalid is decoded before being stored in said first memory.

22. A method according to claim 21, in which identification of the frame as invalid is implemented by a radio frequency decoder, wherein identification of said error is accompanied by:
generation, by the radio frequency decoder, of a status relating to said error, and its storage in a third memory of the NFC device; and
a processing unit of the NFC device is woken up to start an analysis;
said status relative to said error and content of said frame being analyzed, after waking up said processing unit, to modify an operating mode of the NFC device.

23. The method according to claim 22, in which, following analysis of the status relating to said error and of the content of said frame, the NFC device switches to an idle mode or to an activation mode or to a proprietary mode.

24. The method according to claim 22, wherein, when the identification of said error takes place in a protocol mode, then the identification of said error is followed by an interruption of the protocol mode.
